(19) United States
(12) Patent Application Publication
(10) Pub. No.: US 2011/0011391 A1
(43) Pub. Date: Jan. 20, 2011

(54) METHOD AND APPARATUS FOR THE HEAT TREATMENT OF A CELLULOSIC FEEDSTOCK UPSTREAM OF HYDROLYSIS

(75) Inventor: Murray J. Burke, (US)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: SunOpta BioProcess Inc., Brampton (CA)

(21) Appl. No.: 12/837,892

(22) Filed: Jul. 16, 2010

(30) Foreign Application Priority Data
Jul. 17, 2009 (CA) 2673134

(51) Int. Cl. C13K 1/02

(52) U.S. Cl. 127/1; 127/37

(57) ABSTRACT

An apparatus for heating a cellulosic feedstock prior to hydrolysis is disclosed. The apparatus comprises a pressurizable treatment chamber, a mixing and conveyance member configured to deaggregate the cellulosic feedstock and mix the cellulosic feedstock with gas in the upper portion of the chamber, and a heating member. The treatment chamber is at a pressure comparable to the pressure of a downstream hydrolyzer. Additionally, a method is disclosed.

### FIELD

The invention relates to a method and apparatus for preparing a cellulosic feedstock for the subsequent production of a fermentable sugar stream from the cellulose and hemicellulose in the cellulosic feedstock wherein the fermentable sugar stream may be used for subsequent ethanol production. More specifically, the invention relates to a method and apparatus for preparing a cellulosic feedstock for hydrolysis by heating the cellulosic feedstock.

### BACKGROUND

Several processes for the production of ethanol are known. Generally, the production of fuel ethanol involves the fermentation of sugars with yeast. Typically, the sugars are derived from grains, such as corn and wheat. The starches in the grains are subjected to enzymatic hydrolysis in order to produce the sugars, which are then subjected to fermentation to produce ethanol.

Plant materials are a significant source of fermentable sugars, such as glucose that can be transformed into biofuels. However, the sugars in plant materials are contained in long polymeric chains of cellulose and hemicellulose. Utilizing current fermentation processes, it is necessary to break down these polymeric chains into monomeric sugars, prior to the fermenting step.

Recently, processes have been developed for utilizing plant materials, such as corncobs, straw, and sawdust, to produce sugars for ethanol fermentation. Such processes typically comprise pre-treating the feedstock to increase the accessibility of the cellulose to hydrolysis enzymes, and subjecting the cellulose to cellulase enzyme systems to convert the cellulose into glucose.

Methods of converting plant biomass into fermentable sugars are known in the art and in general comprise two main steps: a pre-treatment step to activate the plant structure, and an enzymatic or chemical hydrolysis step to convert the polymeric chains of cellulose and hemicellulose into monomeric sugars. Several approaches have been used for the pre-treatment step, e.g., autohydrolysis, acid hydrolysis, ammonia activation, kraft pulping, organic solvent pulping, hot water pre-treatment, ammonia percolation, lime pre-treatment, caustic soda pulping, or alkali peroxide pre-treatment. Early pre-treatment steps included grinding or milling the feedstock into a powder, which was then mixed with water to form a slurry.

More recently, solvent based pre-treatments, alkali pre-treatments, and acidic pre-treatments have also been described. PCT publication WO/2007/009463 to Holm Christensen describes an alternate pre-treatment, which does not involve the addition of acids, bases, or other chemicals. This pre-treatment process involves soaking the cellulosic material in water, conveying the cellulosic material through a heated and pressurized reactor, and pressing the cellulosic material to produce a fiber fraction and a liquid fraction. During the soaking step, approximately 2.5-3.5 kg of liquid per 1 kg of fiber is added, and is removed again during pressing. The overall pre-treatment process can take about 27 minutes.

Each pre-treatment technology has a different mechanism of action on the plant structure, inducing either physical and/or chemical modifications. However, the main objective of the pre-treatment is to provide accessibility of the plant material to the enzymes.

### SUMMARY

The commercial viability of a hydrolysis process is dependent on the character of the feedstock provided to the hydrolysis unit. Preferably a feedstock is activated such that a significant portion (e.g., greater than 75%) of the cellulose and hemicellulose of the feedstock is accessible to hydrolysis enzymes. If such an activated feedstock is provided to an enzymatic hydrolysis unit, then at least 60%, preferably more than 75% and more preferably over 90% of the cellulose and hemicelluloses may be converted to monomeric sugars. This sugar rich process stream may subsequently be subjected to fermentation to produce an alcohol stream. The alcohol stream from the fermentation stage (i.e., the raw alcohol stream) may have an ethanol content of about 3-22% v/v, preferably about 5-15% and more preferably more about 8-12%.

An activated feedstock for enzymatic hydrolysis is preferably prepared by autohydrolysis, which is preferably conducted in a steam explosion reactor also known as a hydrolyzer or a hydrolysis chamber, (also known as a digester). Autohydrolysis is a process of breaking down hemicellulose and cellulose by exposure to high temperatures, steam and pressure. When performed in the presence of an added acid, the reaction is known as acid hydrolysis.

During autohydrolysis, the degree of polymerization of cellulose may be reduced from about 10,000 to about 1,500-1,000. This process is preferably carried out above the glass transition temperature of lignin (120-160° C.). Depending upon the severity of the reaction, degradation products may be produced, such as furfural, hydroxyl-methylfurfural, formic acid, levulinic acid and other organic compounds.

During a steam explosion treatment (more commonly called autohydrolysis if no externally added catalyst), a cellulosic feedstock is subjected to elevated heat (e.g., 180° C. to 220° C.) and pressure (e.g., 131 psig to 322 psig) optionally in the presence of suitable chemicals (e.g., organic/ and/or inorganic acids, ammonia, caustic soda, sulfur dioxide, solvents etc.) in a pressurized vessel. Preferably, external chemical addition is not utilized, in which case, the only catalyst that may be present may be acetic acid that is generated in situ. The treated cellulosic feedstock is then released from the pressurized vessel such that the pressure is rapidly reduced (e.g., 1 second or less and preferably instantaneously). The biomass may exit the hydrolyzer into a reduced pressure, preferably atmospheric pressure and, more preferably into a vacuum. The rapid decrease in pressure results in the biomass separating into individual fibers or bundles of fibers. This step opens the fiber structure and increases the surface area. The lignin remains in the fiber along with cellulose and residual hemicellulose. Accordingly, the explosive release of pressure, combined with the high temperature and pressure treatment results in the physicochemical modification of the cellulosic feedstock that is then suitable for feeding to an enzymatic hydrolysis unit.

It has also been determined that if the cellulosic feedstock that is fed to a hydrolyzer has a temperature that is too high, then some percentage of the hemicellulose sugars will be degraded to inhibitory compounds prior to starting the autohydrolysis reaction and further amounts during the autohydrolysis reaction itself. Conversely, if the fiber is too cold entering the hydrolyzer, the first one third to one half of the reactor vessel may act as a preheating device rather than as an autohydrolysis reactor, resulting in incomplete autohydrolysis. It is preferred to have very consistent fiber temperature year round as well as from night to day time operation, for the fiber that is fed to the hydrolyzer.

In addition, it is preferred that the fiber in the feedstock fed to the autohydrolysis unit have a relatively uniform temperature profile. For example, it is preferred that the core of the feedstock material have a temperature that is within 80%, more preferably 90%, most preferably 95% of the temperature of the exterior surface of the material.

Accordingly, in one aspect there is provided a method for preparing a cellulosic feedstock for hydrolysis in a hydrolysis chamber, the method comprising:

a) introducing the cellulosic feedstock into a longitudinally extending treatment chamber having an inner surface;

b) operating the treatment chamber at a pressure comparable to the pressure in the hydrolysis chamber and at a fill volume less than 50% whereby the treatment chamber has an upper open portion;

c) projecting a portion of the cellulosic feedstock into the upper open portion of the treatment chamber while conveying the cellulosic feedstock longitudinally through the treatment chamber; and,

d) heating the cellulosic feedstock as it is conveyed through the chamber.

In some embodiments, step (c) may comprise deaggregating the cellulosic feedstock in a lower portion of the treatment chamber and dispersing the deaggregated cellulosic feedstock in the open upper portion.

It has been determined that the inner portion of a cellulosic feedstock that is placed in a hydrolyzer having heated walls and conveyed by a slowly rotating auger, e.g., 4 rpm as may be used in a hydrolyzer, will tend to heat slowly. While the portion in contact with the heated surface will be heated to the desired hydrolysis temperature relatively quickly, the conduction of heat into the interior is limited, even with the mixing effected by the auger. Accordingly, while the portion in contact with the heated surface will be raised to the hydrolysis temperature, some may overheat and be degraded. Further, the interior portion may not be raised to a desired temperature for hydrolysis for a sufficient time for the hydrolysis reaction to proceed to a desired degree of completion before the feedstock is ejected from the hydrolyzer. Accordingly, in accordance with this aspect of the invention, the feedstock is subjected to heating in a partially filled reactor. The reactor is operated with part of the volume being occupied by a gas (e.g., air, which may be moist due to the addition of water that vapourizes to produce steam). The feedstock is projected, e.g., thrown, up into the open volume of the reactor by, e.g., rapidly rotating paddles. Accordingly, instead of the cellulosic feedstock remaining in the bottom of the reactor as a compact mass of material, portions of the feedstock are separated from each other thereby exposing more of the surface area of the feedstock to a hot atmosphere in the open upper portion of the reactor. This will result in the interior portion of the feedstock being heated as the material is projected upwardly and as it falls downwardly due to gravity to settle in the bottom of the reactor.

In some embodiments, step (d) may comprise indirectly heating the cellulosic feedstock. In alternate embodiments, some water may be added in the treatment chamber. For example, the feedstock may be sprayed with water, e.g., a fine mist, while maintaining the moisture content of the feedstock preferably between 30 and 60 wt %, and more preferably between 45 and 55 wt %, as it enters the treatment chamber and/or steam may be introduced into the treatment chamber.

In some embodiments, step (c) may utilize a conveyance member and step (d) comprises heating at least one of the inner chamber surface and the conveyance member and preferably both of the inner chamber surface and the conveyance member. Preferably, the conveyance member is internally heated by a fluid, e.g., steam.

In some embodiments, step (d) may comprise heating the feedstock to between 170° C. and 220° C. and preferably between 200° C. and 210° C.

In some embodiments, the cellulosic feedstock may be heated in the absence of the addition of moisture.

In some embodiments, step (a) may comprise providing a cellulosic feedstock at a temperature between 5° C. and 100° C., preferably between 50 and 70° C., and a moisture content between 30 and 60 wt %, and preferably between 45 and 60 wt %.

In some embodiments, the fill volume of the cellulosic feedstock in the chamber may be from 5 to 30%, preferably 5% to 25%, more preferably 5%-20% and most preferably 5%-15%.

In some embodiments, the chamber is operated at a pressure of between 75 and 500 pounds per square inch gauge (PSIG) preferably between 170 and 265 PSIG such as if the hydrolysis is conducted without acid addition and, more preferably 190-235 PSIG.

In some embodiments, the cellulosic feedstock may be subjected to a downstream hydrolysis process in the hydrolysis chamber. The hydrolysis chamber is preferably contiguous with the treatment chamber. For example, the treatment chamber and hydrolysis chamber may be a continuous volume in a vessel.

Alternately, the hydrolysis chamber may be in a separate vessel, e.g. a hydrolyzer, and the treatment chamber has an outlet and the hydrolysis chamber has an inlet and the method further comprises conveying the cellulosic feedstock through a conduit connecting the treatment chamber and the hydrolysis chamber. Preferably, the inlet is above the outlet and the method further comprises conveying the cellulosic feedstock downwardly from the treatment chamber to the hydrolysis chamber. The feedstock may travel between the chambers solely due to gravity.

In some embodiments, the treatment chamber may be at the same pressure as the hydrolysis chamber.

In some embodiments, the method may further comprise sweeping a lower surface to convey the cellulosic feedstock through the treatment chamber.

In some embodiments, the conveyance member may comprise a rotary shaft extending longitudinally through the treatment chamber and a plurality of paddles extending radially outwardly from the shaft, and the conveyance member may include a fluid conduit extending longitudinally through at least one of the shaft and the plurality of paddle ducts, and the step of heating the cellulosic feedstock may comprise injecting a heated fluid through the fluid conduit.

In some embodiments, the conveyance member may be rotated at a rate of between 25 and 150 RPM, preferably between 50-100 RPM and more preferably about 75 RPM.

In accordance with another aspect there is provided an apparatus comprising:

a) a shell defining a pressurizable treatment chamber having a lower inner surface, the shell having an inlet and an outlet spaced longitudinally apart from the inlet to define an axial length, the outlet being at a pressure comparable to a hydrolysis chamber downstream from the treatment chamber;

b) a mixing and conveyance member housed within the shell; and,

c) a heating member configured to heat at least one of the shell and the mixing and conveyance member whereby the cellulosic feedstock is heat-treated prior to hydrolysis.

In some embodiments, the pressurizable treatment chamber may be contiguous with the hydrolysis chamber. For example, the pressurizable treatment chamber and the hydrolysis chamber may be provided within the shell. Alternately the treatment chamber and the hydrolysis chamber may be provided in separate vessels and are connected by a conduit. In this latter embodiment, the outlet of the pressurizable treatment chamber is preferably above, and more preferably directly above, an inlet of the hydrolysis chamber.

In some embodiments, the conveyance member may be configured to disperse the feedstock throughout the treatment chamber.

In some embodiments, the heating member may comprise at least one of a heating jacket and a fluid flow conduit internal to the mixing and conveyance member. Preferably, the fluid flow conduit is isolated from fluid flow communication with the treatment chamber.

In some embodiments, the mixing and conveyance member may comprise at least one portion configured to sweep the lower inner surface of the treatment chamber.

In some embodiments, the hydrolysis chamber has a conveyance member and the mixing and conveyance member may be operable at a higher RPM then the conveyance member.

In some embodiments, the apparatus may have more than one conveyance member. For example, the conveyance member may comprise a second shaft, spaced transversely apart from and extending generally parallel to the first shaft and the lower inner surface is scallop shaped in transverse section. In one such embodiment, the second shaft is spaced transversely apart from and extending generally parallel to the first shaft. Each shaft may have a plurality of paddles attached thereto. Each paddle may be bolted to the shaft to allow adjustment of the angles for optimal mixing of the feedstock. The lower inner surface has a first portion below the first shaft and a second portion below the second shaft wherein, and when viewed in transverse cross section, each the first portion defines an arc at a constant distance to the first shaft and the second portion defines an arc at a constant distance to the second shaft

### BRIEF DESCRIPTION OF THE DRAWINGS

These and other advantages of the present invention will be more fully and particularly understood in connection with the following description of the preferred embodiments of the invention in which:

FIG. 1 is a perspective illustration of an embodiment of an apparatus of the present invention;

FIG. 2 is a front plan view of the apparatus of FIG. 1;

FIG. 3 is a top plan view of the apparatus of FIG. 1;

FIG. 4 is a top view of the apparatus of FIG. 1, with the upper portion of the apparatus removed, showing the interior of the apparatus;

FIGS. 5A and 5B are transverse cross-sections taken along line 5-5 in FIG. 2, showing various rotational positions of an embodiment of a conveyance member of the present invention;

FIG. 6 is a perspective illustration of an embodiment of a conveyance member of the present invention;

FIG. 7A is a perspective illustration of an embodiment of a paddle of the present invention;

FIG. 7B is a front plan view of the paddle of FIG. 7A;

FIG. 7C is a side plan view of the paddle of FIG. 7A;

FIG. 7D is a top plan view of the paddle of FIG. 7A;

FIG. 8A is a partial perspective illustration of an embodiment of a conveyance member of the present invention, wherein the paddle of the conveyance member comprises a shaft with a fluid conduit extending through the shaft;

FIG. 8B is a partial front plan view of the paddle of FIG. 8A;

FIG. 8C is a partial side plan view of the paddle of FIG. 8A;

FIG. 8D is a transverse cross-section taken along line D-D in FIG. 8A showing fluid communication between the shaft and a paddle duct;

FIG. 9 is a schematic drawing of an apparatus according to one embodiment of the present invention wherein the treatment chamber is in a separate vessel from the hydrolysis chamber; and,

FIG. 10 is a schematic drawing of an apparatus according to another embodiment of the present invention wherein the treatment chamber is in the same vessel as the hydrolysis chamber.

### DETAILED DESCRIPTION

Embodiments of the present invention provide a method and apparatus for treating a cellulosic feedstock that may be used for subsequent ethanol production. The method and apparatus of the preferred embodiment serve to heat the feedstock to obtain a feedstock suitable for hydrolysis. In one of the preferred embodiments, the method and apparatus serve to indirectly heat the feedstock without increasing the moisture content of the feedstock. In a further embodiment, the method and apparatus serve to increase the amount of the feedstock exposed to heat in order to improve heat transfer to the interior portion of the cellulosic feedstock that is fed to a treatment chamber. The method and apparatus are useful for preparing a cellulosic feedstock for autohydrolysis in a hydrolyzer, such as a steam explosion hydrolyzer. Accordingly, the embodiments described herein provide a cellulosic feedstock, which is suitable for the production of a fermentation precursor stream. The cellulosic feedstock may be subsequently treated to liberate sugars in the cellulose and hemicellulose and produce a sugar stream that may then be subjected to fermentation to obtain a high yield alcohol stream.

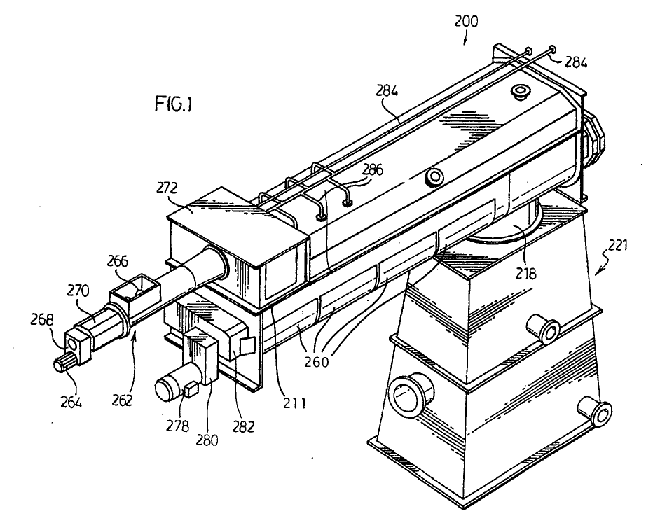

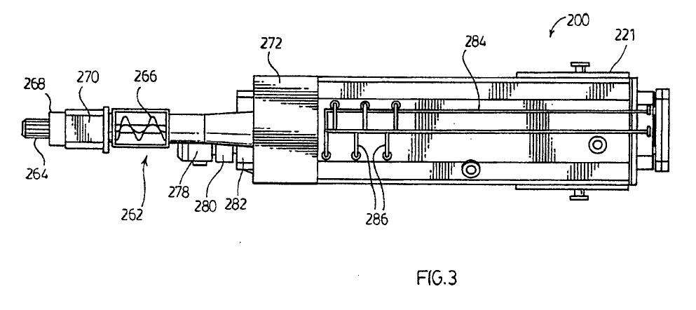

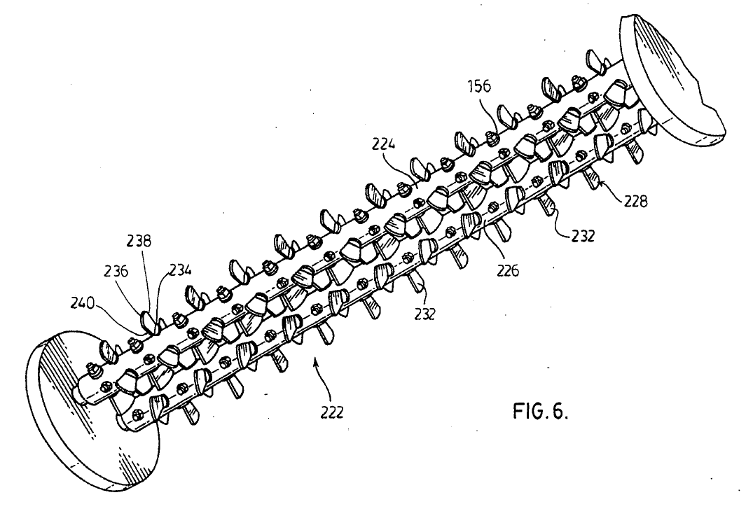

An embodiment of an apparatus of the present invention is shown in FIGS. 1-8. It will be appreciated that although the method is described with reference to apparatus 200 and vice versa, the method may be carried out with an alternate apparatus, and apparatus 200 may be used according to an alternate method. Furthermore, although the method is described as a continuous process, it will be appreciated that the method may be carried out as a semi-continuous or batch process.

The cellulosic feedstock treated according to the methods described herein or utilizing apparatus 200 is preferably a lignocellulosic feedstock. A lignocellulosic feedstock is derived from plant materials. As used herein, a “lignocellulosic feedstock” refers to plant fiber containing cellulose, hemicellulose and lignin. In some embodiments, the feedstock may be derived from trees, preferably deciduous trees such as poplar (e.g., wood chips). Alternately or in addition, the feedstock may also be derived from agricultural residues such as, but not limited to, corn stover, wheat straw, barley straw, rice straw, switchgrass, sorghum, bagasse, rice hulls and/or corn cobs. Preferably, the lignocellulosic feedstock comprises agricultural residues and wood biomass, more preferably wood biomass and most preferably deciduous. The applicants contemplate other sources of plant materials comprising cellulose, hemicellulose and/or lignin, such as algae, for use in deriving cellulosic feedstocks and any of those may be used.

The lignocellulosic feedstock is preferably cleaned, e.g., to remove ash, silica, metal strapping (e.g., from agricultural products), stones and dirt. The size of the components of the lignocellulosic feedstock may also be reduced. The size of the components of the feedstock may be from about 0.05 to about 2 inches, preferably from about 0.1 to about 1 inch, and more preferably from about 0.125 to about 0.5 inches in length. For example, the cellulosic feedstock may comprise fibers, e.g., chopped straw, of a length of between about 4 mm and about 7 mm. Any process machinery that is able to crush, grind or otherwise decrease the particle size may be utilized.

In some embodiments, the methods and apparatus heat the cellulosic feedstock without the addition of moisture. It is preferred to have a lower moisture content in the feedstock provided that sufficient water is present for hydrolyzing and/or activating the feedstock. In one aspect, the moisture content of the lignocellulosic feedstock provided to apparatus 200 is preferably between 30% and 70% water by weight. In more preferred embodiments, the moisture content of the lignocellulosic feedstock is between 45% and 55%. In some embodiments, the cellulosic feedstock is pre-treated in an impregnator in order to adjust the moisture content of the feedstock prior to being provided to apparatus 200. For example, the moisture content of a feedstock may be measured and a predetermined amount of water may then be added to the feedstock in an impregnator order to pre-treat the feedstock and arrive at the preferred moisture content. It is also preferred that the fiber in the feedstock fed to the heat treatment chamber have a relatively uniform moisture profile. It is preferred that the core of the feedstock have a moisture content that is within 80%, more preferably 90%, most preferably 95% of the moisture content of the exterior surface of the material. For example, if the moisture content of the exterior surface of the material is from 45 to 55 wt %, then the moisture content of the core of the material is preferably from 40.5 to 49.5 wt %.

Optionally, in some embodiments the feedstock provided to apparatus 200 is pre-treated in order to heat the feedstock. In some embodiments, the feedstock is at a temperature of between 25 and 100° C. , preferably 50 and about 70° C. and more preferably 55 and 65° C. and a moisture content of between about 30% and 70% by weight, and in a preferred embodiment between about 45% and 55% by weight. In one preferred embodiment, cellulosic material is pre-treated in an impregnator to obtain a cellulosic feedstock at these conditions.

In accordance with one aspect of the present invention the method comprises heating the cellulosic feedstock as it is conveyed through an enclosed volume. The enclosed volume may be of a variety of configurations. In one embodiment, the enclosed volume is a longitudinally extending chamber. Referring to FIGS. 1-5, in the embodiment shown, chamber 204 of apparatus 200 comprises an enclosed volume 202. Chamber 204 may be referred to as a treatment chamber.

In the embodiment shown, chamber 204 is defined by a shell 206, which preferably is provided with a heating jacket 260. The chamber is a pressurizable chamber that may be operated between 75 and 500 PSIG, preferably between 170 and 265 PSIG such as if the hydrolysis is conducted without acid addition and, more preferably 190-235 PSIG. Shell 206 preferably comprises an inner wall 208 and a spaced apart outer wall 209 defining a volume 207 therebetween. Accordingly, chamber 204 may be a double walled chamber having a volume 207 through which a heated fluid may be passed from, e.g., inlet to the volume 207 to the outlet from the volume. Wall 208 has an inner surface 210 that encloses chamber 204. It will be appreciated that a single walled vessel may be used. It will be appreciated that heating jacket 260 may surround only part of chamber 204 and may be of any design.

Feeder 262 that provides feedstock into chamber 204 is preferably positioned upstream of treatment chamber 204. Feeder 262 may be of any design and is preferably a co-axial feeder as exemplified in Canadian patent application no. 2,339,002. Preferably, feeder 262 is a high-pressure feeder and inhibits, and preferably produces a plug of material that prevents upstream migration of the feedstock. The plug may be conveyed into inlet housing 272 that is mounted, e.g., to outer wall 209 and positioned above inlet 211 to volume 202. The feedstock may then pass downwardly into chamber 204.

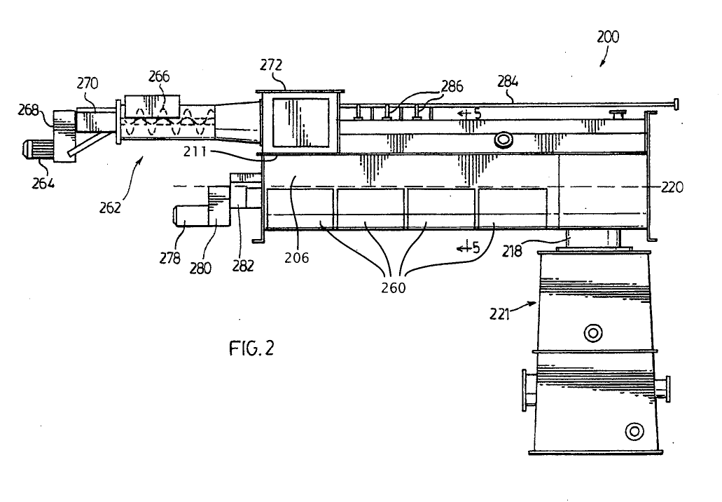

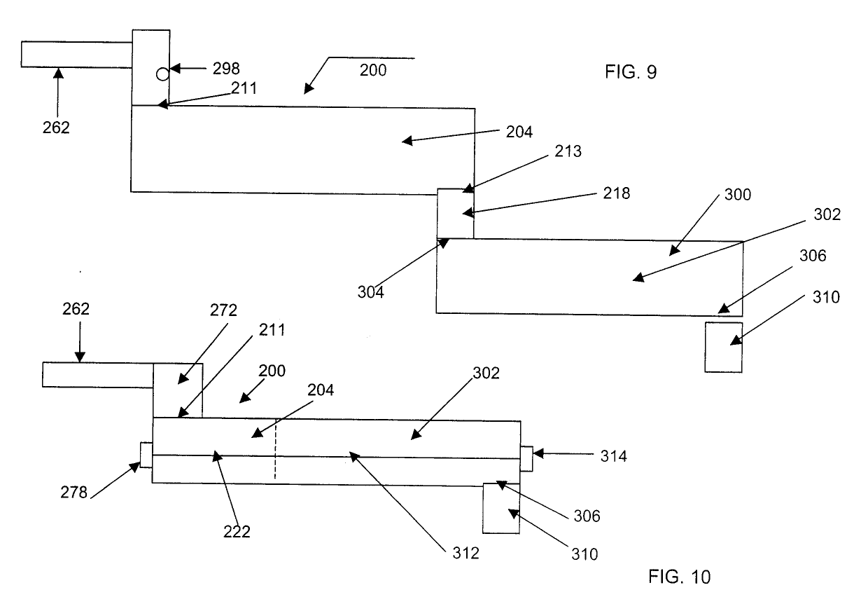

In the embodiment shown in FIG. 9, treatment chamber 204 is in a separate vessel to the hydrolysis chamber. Accordingly, chamber 204 comprises at least one feedstock inlet 211, and at least one treated feedstock outlet 213, which may be positioned above outlet passage 218 (see FIGS. 2 and 4). Inlet 211 and outlet 213 are spaced axially apart to define a length L. Length L may vary depending on the particular embodiment, however, in some embodiments, length L may be between about 5 ft and about 25 ft. In the embodiment shown, inlet 211 is defined in upper portion of shell 206, and outlet 213 is defined in lower portion of shell 206. Accordingly, the cellulosic feedstock is deposited into inlet 211, is conveyed along the length of chamber 204 and drops out of outlet 213 into optional outlet passage 218. It is preferred that outlet passage 218 extends downwardly and, preferably vertically. Accordingly, processed feedstock exiting heat treatment chamber 204 may pass solely due to gravity into hydrolyzer 300. In alternate embodiments, inlet 211 and outlet 213 may be positioned elsewhere, for example at opposed ends of chamber 204.

As exemplified in FIG. 9, outlet passage 218 is connected to a hydrolyzer 300 having a hydrolyzer chamber 302, an inlet 304 in communication with outlet passage 218 and an outlet 306 that is preferably a steam explosion outlet. Passage 310 extends from outlet 306 to a downstream process unit, such as an enzymatic hydrolysis unit. Hydrolyzer 300 may be operated at a fill factor of 50% or less, preferably less than 40% and more preferably about 25%.

In this embodiment, treatment chamber 204 may have a residence time of a minute or less, e.g., 30-45 seconds and hydrolysis chamber 302 may have a residence time of about 3-14 minutes, preferably 5-9 minutes. If the hydrolysis chamber 302 is operated at a high fill factor (e.g., 75-90%) and the chambers are of about the same size, then if the fill factor of the treatment chamber 204 is too high, fibre will start to build up in the treatment chamber and some of the feedstock may be overheated. Accordingly, the residence time in the treatment chamber and in the hydrolysis chamber are preferably selected such that the treated feedstock may exit the treatment chamber directly to the hydrolysis chamber and achieve the desired fill volume in the hydrolysis chamber.

In the embodiment shown in FIG. 10, treatment chamber 204 is in the same vessel as the hydrolysis chamber 302. Accordingly, the hydrolyzer is contiguous with the treatment chamber 204. Preferably, in this embodiment hydrolysis chamber 302 has a conveyance member 312 that may be operated independently of conveyance member 222 of treatment chamber 204. Accordingly, conveyance member 222 of treatment chamber 204 may operate relatively rapidly to project material into the open volume of treatment chamber 204 and conveyance member 302 of hydrolysis chamber 302 may operate slower. Each may be a cantilevered member and be driven by a motor 278, 314. Conveyance members 222 and 312 may the same or different and may be any member known in the arts.

The cellulosic feedstock is heated without the addition of moisture to the feedstock as it travels through the treatment chamber 204. Preferably, the cellulosic feedstock is heated such that, when the feedstock exits the treatment chamber 204, e.g., at outlet 213, the feedstock is at a temperature of between about 170 to about 220° C., and preferably between about 200° C. to about 210° C.

Chamber 204 may be of any configuration that provides a residence time for the feedstock to be agitated and heated so as to obtain a treated feedstock having a temperature within a predetermined range, and which is preferably uniform. In one embodiment, the feedstock is heated without the direct addition of moisture, such as hot water or steam, to the feedstock. In another embodiment, water may be added such as by steam injection into the treatment chamber 204 and/or by spraying water onto the feedstock entering chamber 204 (e.g., a water spray jet 298 or the like may be provided in inlet housing 272).

In one preferred aspect, the chamber and a conveyance member 222 are configured such that the feedstock is moved through the chamber with a relatively constant residence time. Alternately, or in addition, the chamber and a conveyance member 222 are configured such that the lower surface on which the feedstock may rest under the influence of gravity is swept such that feedstock will be continually urged through the chamber.

In a further aspect, conveyance members 222 also serves to agitate the feedstock as it is urged through the chamber. Agitating the feedstock encourages the mixing of the cellulosic feedstock and in another embodiment encourages the efficient and uniform transfer of heat to the feedstock. In the exemplified embodiments, agitating the feedstock mixes and disperses the feedstock into enclosed volume 202 and throughout the fill volume of the chamber 204. It will be appreciated that dispersing the feedstock throughout chamber 204 encourages contact of the feedstock with inner surface 210 of chamber 204, which promotes heat transfer from shell 206 to the cellulosic feedstock contained therein. It will be further appreciated that agitating the cellulosic feedstock mixes the feedstock and promotes heat transfer within the feedstock as it is conveyed through the chamber.

It will be appreciated that conveyance member 222 may be of any design that will project a portion, and preferably all, of the cellulosic feedstock into the upper open portion of the treatment chamber while conveying the cellulosic feedstock longitudinally through the treatment chamber. As the conveyance member rotates, preferably at a relatively high speed, the feedstock will be projected up and dispersed into volume 202 of chamber 204. A person skilled in the art will appreciate that increasing the speed of rotation of the conveyance member will generally increase the agitation and the speed at which the feedstock is conveyed through the chamber.

The amount of material projected upwardly will depend upon the rate of rotation and the design of the conveyance member. In a particular preferred aspect, treatment chamber 204 is operated substantially empty (e.g., a fill volume of about 10%) so that much of the fiber in chamber 204 may be dispersed in the open upper volume of chamber 204 at any time. Accordingly, the feedstock may be essentially in nearly continuous movement in the vertical direction as it travels longitudinally through housing 204. For example, as conveyance member 222 rotates, a portion of the feedstock may be thrown into the air. The feedstock will then separate and be dispersed into the gas in the chamber. Accordingly, more of the surface area of the feedstock will be exposed to the hot gas in the chamber. The feedstock will then fall downwardly to the bottom of the chamber whereupon the process will be repeated. The feedstock may spend over 40%, preferably over 50% and more preferably over 75% of its residence time air born.

As exemplified in FIGS. 1-3, two conveyance members 222 are rotatably mounted in chamber 204 and are drivenly connected to a motor 278. As exemplified, motor 278 is drivingly connected to conveyance members 222 via a transmission or gear reduction assembly provided in housing 280. The gear reduction assembly may be drivingly connected to ends 225, 227 of conveyance members 222 that are positioned inside housing 282.

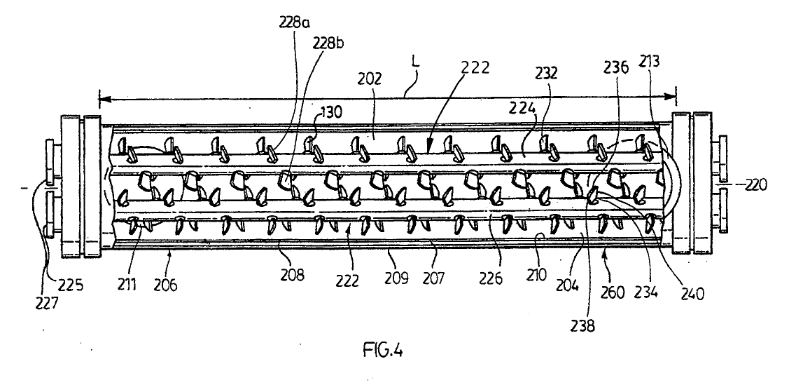

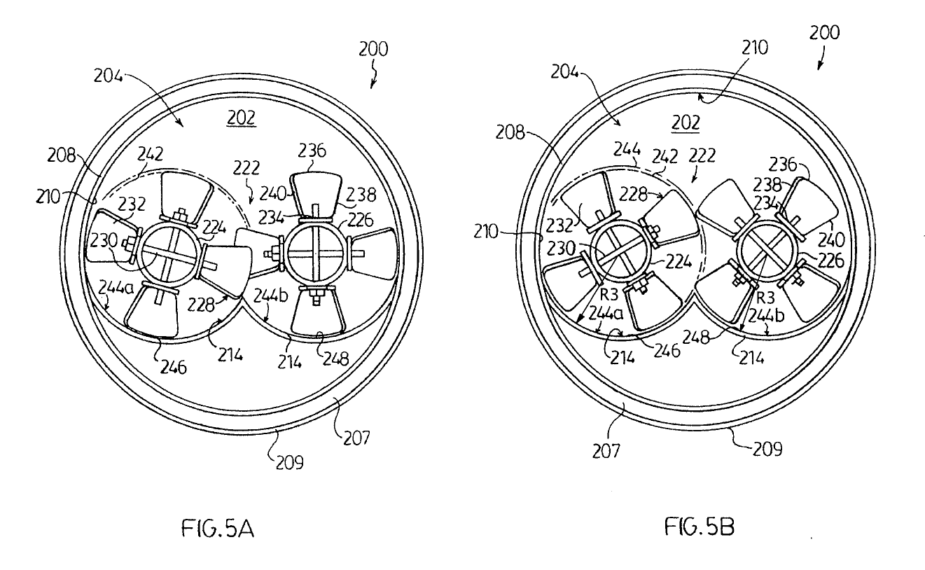

In accordance with this preferred aspect, chamber 204 extends longitudinally along axis 220 and has an upper portion that may be substantially cylindrical and a lower portion formed by wall section 214 that is preferably scallop shaped in transverse section (see FIGS. 5A and 5B). An advantage of having a scallop shaped lower section is that a rotary mounted conveyance member 222 may sweep adjacent all of, or at least much of, lower wall section 214 to reduce the likelihood of material having an increased residence time by not being conveyed along wall section 214. In alternate embodiments that are less preferred, chamber 204 may be otherwise shaped. For example, the upper portion may also be scallop shaped. Alternately, in combination with other aspect of this invention, the lower portion may be substantially cylindrical, in which case a single conveyance member 222 may be used.

Preferably, conveyance member 222 is configured, in conjunction with the configuration of lower wall section 214, to urge the cellulosic feedstock through chamber 204 by sweeping lower wall section 214. That is, conveyance member 222 is preferably configured such that at least a portion thereof passes over lower inner surface in a continuous motion to push the cellulosic material forwardly. Furthermore, conveyance member 222 is preferably configured to sweep lower wall section 214 along generally the entire axial length of the chamber. Accordingly, the likelihood of feedstock staying in contact with lower wall section 214 for a period of time such that the fibre is degraded by a heated fluid in volume 207 is reduced and preferably essentially eliminated. It will be appreciated that, in less preferred embodiments, lower wall section 214 and conveyance member 222 need not be configured to sweep lower wall section 214 and may be of a variety of other configurations. Such an embodiment may be used if volume 207 is not heated by steam.

As exemplified in FIGS. 4-8, conveyance member 222 comprises first rotary shaft 224 and second rotary shaft 226, which extend longitudinally through chamber 204, and which are preferably spaced transversely apart and are preferably parallel. In alternate embodiments, conveyance member may comprise only one rotary shaft, or more than two rotary shafts.

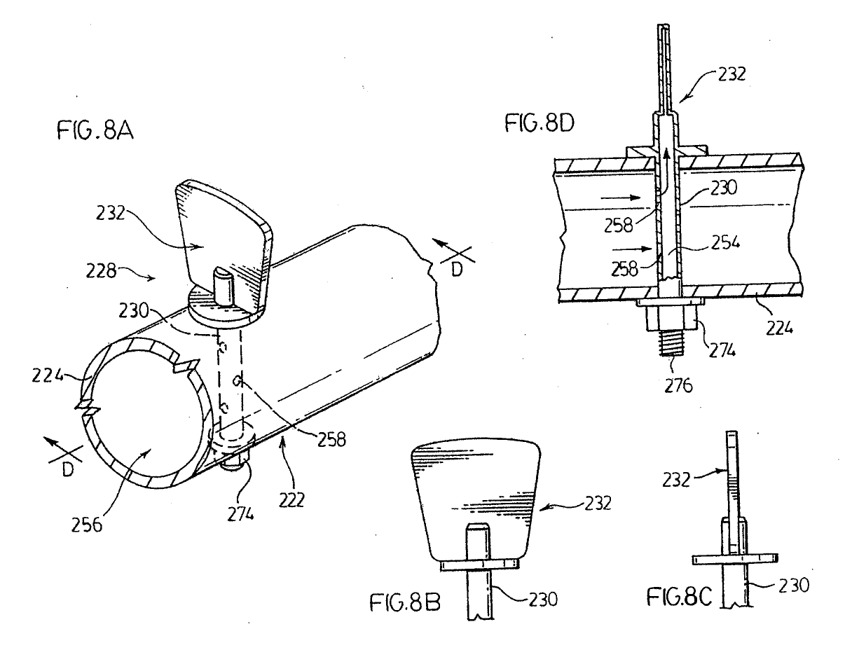

Shafts 224 and 226 may be provided with an auger, a plurality of paddles or any member that is configured to project the feedstock into the open volume as shafts 224 and 226 rotate. As exemplified, a plurality of paddles 228 extend radially outwardly from each rotary shaft. In addition, as exemplified in FIGS. 8A-8D, paddles 228 may each comprise a blade 232 and a stem 230, which couples the blade 232 to one of rotary shafts 226 and 228. Each blade 232 may be generally planar, and comprise a radially inner edge 234, a radially outer edge 236, and opposing first 238 and second 240 side edges, which extend between inner edge 234, and outer edge 236. In other embodiments, the paddles may be otherwise configured. For example, the blade may extend directly from the shaft, and a stem may not be provided. Alternatively as exemplified, the stem may extend outwardly from the shaft, such that a space is provided between each blade and the shaft.

Blade 232 may be secured to one end of stem 230 by any means known in the art, such as welding, or mechanical affixation members such as rivets, or screws. The other end of stem 230 may be provided with a screw thread 276 on which bolt 274 may be received. Stem 230 may be secured to shaft 224 and 226 such as by extending transversely through shaft 224 and 226 from one side to the other and bolt 274 secured thereon. Preferably, if a fluid conduit is provided in conveyance member 222, suitable packing, gaskets or the like are provided to limit or prevent fluid communication between volume 256 of shaft 224 and enclosed volume 202 of chamber 204, such as past stem 230.

Stem 230 may be provided with one or more openings 258 in fluid communication with volume 256 inside shaft 224 and 226. Stem 230 may also be in fluid communication with a paddle duct enclosed within blade 232. Accordingly, fluid may flow through shaft 224 and 226, through stem 230 to an enclosed duct in blade 232. In another embodiment, blade 232 does not comprise a paddle duct in fluid communication with stem 230 and volume 256. Optionally, paddles 228 may also be directly secured to shafts 224 and 226 or may be secured by any other means known in the art.

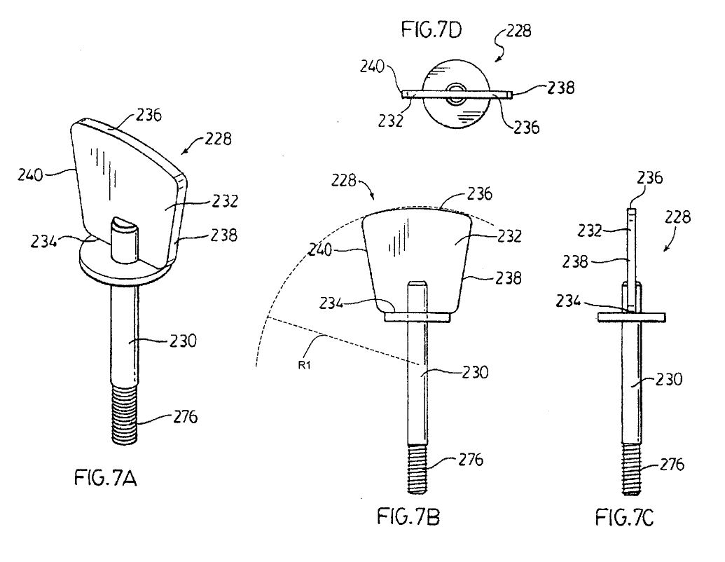

In one embodiment, as exemplified in FIG. 7, paddles 228 are arranged such that they generally define a longitudinally extending helix extending around each rotary shaft. In other words, a helix would be defined if the radially outer edge 236 of paddles were connected by a line extending from the inlet end of a rotary shaft to the outlet end thereof. Accordingly, helically adjacent paddles 228, for example paddles 228a and 228b, extend from the shaft at different angular positions around the shaft axis, as can be seen in FIG. 4.

Preferably, blades 232 of each paddle 228 are canted. That is, a first side edge 238 of each blade 232 is axially nearer the outlet 213 and rotationally trailing relative to a second side edge 240 (see FIG. 5).

Preferably, when viewed axially along the length of a rotary shaft, the first side edge of one paddle axially overlaps the second side edge of a next adjacent paddle (See FIG. 5A).

In alternate embodiments, the paddles may be otherwise configured. For example, they may not be canted, and may be wedge shaped. Additionally, they may, for example, be arranged in a grid around shafts 226 and 224, rather than in a helix.

Accordingly, in the embodiment shown, the step of projecting and/or conveying the cellulosic feedstock through the enclosed volume 202 comprises rotating each shaft 224 and 226, such that the paddles 228 engage the cellulosic feedstock and convey the cellulosic feedstock up into the open volume of the chamber 204 and urge the cellulosic feedstock axially through the chamber 204. Furthermore, in this embodiment, when the rotary shafts 224 and 226 rotate, paddles 228 pass over inner lower wall section 214 in a continuous motion to push the cellulosic material forwardly. An advantage of the exemplified design is that the outer radial edges of the blades are configured to travel a generally consistent distance above lower wall section 214, thereby being able to effectively sweep lower wall section 214.

In accordance with this particularly preferred aspect, paddles 228 and lower wall section 214 are configured such that when a given paddle is adjacent and passing over lower wall section 214, a substantially constant distance is maintained between the outer edge 236 of the paddle 228, and lower wall section 214.

For example, in the embodiments shown, the outer edge 236 of each paddle is curved or arcuate in shape (see for example FIG. 7B), and the curve preferably matches an arc 242 swept or defined by the outer edge 236 as the shafts rotate (see for example FIG. 5A). Accordingly, when shafts 224 and 226 rotate, the outer edge 236 of each paddle 228 will describe a circle. That is, outer edge 236 of each blade 232 is curved to define a sector of a circle having a radius R1. It will be appreciated that in embodiments wherein the blades 232 are canted, the arc 242 swept by outer edge 236 will be 3-dimensional (i.e. will have a depth).

It will be appreciated that lower wall section 214 may be configured such that in transverse section lower wall section 214 defines at least one arc 244 and more preferably two or more arcs. In the embodiment shown, wherein conveyance member comprises two rotary shafts, lower wall section 214 defines two arcs 244a, 244b as shown in FIGS. 5A-5B. That is, when viewed in transverse section, lower wall section 214 is scallop shaped. In alternate embodiments, wherein conveyance member comprises a different number of shafts, lower portion may define a different number of arcs, preferably one per shaft. Preferably, each shaft is centered above an arc 244.

Arcs 244a and 244b have a radius R3. Arc 244a comprises first portion 246 of lower wall section 214, and arc 244b comprises second portion 248 of lower wall section 214. First portion 246 is below first shaft 224, and second portion is below second shaft 226. Blades 232 and portions 246 and 248 are configured such that R3 is of a slightly greater radius than R2, for example less than about 6.5 mm greater than R2. Accordingly, when shafts 224 and 226 rotate, the paddles associated with shaft 224 will sweep along first portion 246, and the paddles associated with shaft 226 will sweep along second portion 248, such that a distance preferably less than about 6.5 mm is maintained between outer edge 236 of paddles 228 and first 246 and second 248 portions of lower wall section 214 as the paddles pass adjacent to lower wall section 214. The spacing between radial outer edge 236 and arc 244 may be from 2 to 15 mm. The spacing may vary depending upon the size of the particulate matter in the feedstock. The larger the size of the particulate matter, the larger the spacing may be. Preferably, the spacing is less than the maximum particle size and, more preferably, less than the median particle size. Accordingly, as the shafts rotate, particulate matter will be continually moved through the chamber.

It will be appreciated that shafts 224 and 226 may rotate in the same direction, or in opposite directions. Further, it will be appreciated that the rotation of shafts 224 and 226 may be driven by a motor as exemplified, or another suitable means.

The cellulosic feedstock may be heated in a variety of ways. In a preferred embodiment, the cellulosic feedstock is heated indirectly. For example, in some embodiments, the cellulosic feedstock is heated indirectly as it is conveyed through the chamber 204 by heating surfaces that are in contact with the cellulosic feedstock. Accordingly, in such embodiments, the method may comprise heating a fluid prior to contacting the fluid with a surface of the treatment chamber or conveyance member, which is in contact with the feedstock thereby indirectly heading the feedstock.

For example, the shell 206 of chamber 204 and/or the conveyance member 222 may be heated. Referring to FIGS. 4 and 5, in the embodiments shown, the chamber walls 208 are heated by providing an outer wall 209, which surrounds at least a portion of shell 206. An enclosure 207 is defined between outer wall 209 and inner wall 208, and a heated fluid supply is associated with the enclosure. Enclosure 207 is in fluid communication at one end with one or more inlets, to which a heated fluid is supplied, and at the other end with one or more outlets, to which spent heated fluid is directed. Accordingly, the heated fluid circulates within enclosure 207, and provides heat to the cellulosic feedstock. The heated fluid may be water, for example, or steam. Any heating jacket or the like known in the art may be used. In one such embodiment, the cellulosic feedstock is heated by a heating member 260 configured to heat shell 206 or conveyance member 222.

Alternately, or in addition, conveyance member 222 may also be heated. In one such embodiment, conveyance member 222 may be internally heated by a heating member. In one embodiment, conveyance member 222 comprises a shaft 224 and 226 with fluid conduit 256. A heated fluid supply is associated with fluid conduit 256 whereby heated fluid is passed through fluid conduit 256 thereby heating conveyance member 222. In a preferred embodiment, conveyance member 222 further comprises paddle ducts 254 in fluid communication with fluid conduit 256 through ports 258 in stem 230. Preferably, fluid conduit 256 and paddle duct 254 are not in fluid communication with enclosed volume 202 of chamber 204 to prevent leakage of fluid into, or out of, chamber 204. A heated fluid supply is associated with the fluid conduit 256 such that the heated fluid is passed through fluid conduit 256 and port 258 in stem 230 and into paddle duct 254. It will be appreciated that, if water is to be added, it may be added by venting steam into chamber 204 by providing ports on the inner wall of chamber 204 and/or in an exterior surface of conveyance member 222.

It will be appreciated that certain features of the invention, which are, for clarity, described in the context of separate embodiments or separate aspects, may also be provided in combination in a single embodiment. Conversely, various features of the invention, which are, for brevity, described in the context of a single embodiment or aspect, may also be provided separately or in any suitable sub-combination.

Although the invention has been described in conjunction with specific embodiments thereof, if is evident that many alternatives, modifications and variations will be apparent to those skilled in the art. Accordingly, it is intended to embrace all such alternatives, modifications and variations that fall within the spirit and broad scope of the appended claims. In addition, citation or identification of any reference in this application shall not be construed as an admission that such reference is available as prior art to the present invention.

1. A method for preparing a cellulosic feedstock for hydrolysis in a hydrolysis chamber, the method comprising:
a) introducing the cellulosic feedstock into a longitudinally extending treatment chamber having an inner surface;
b) operating the treatment chamber at a pressure comparable to the pressure in the hydrolysis chamber and at a fill volume less than 50% whereby the treatment chamber has an upper open portion;
c) projecting a portion of the cellulosic feedstock into the upper open portion of the treatment chamber while conveying the cellulosic feedstock longitudinally through the treatment chamber; and,
d) heating the cellulosic feedstock as it is conveyed through the chamber.

2. The method of claim 1, wherein step (c) comprises deaggregating the cellulosic feedstock in a lower portion of the treatment chamber and dispersing the deaggregated cellulosic feedstock in the open upper portion.

3. The method of claim 1, wherein step (d) comprises indirectly heating the cellulosic feedstock.

4. The method of claim 1, wherein step (c) utilizes a conveyance member and step (d) comprises heating at least one of the inner chamber surface and the conveyance member.

5. The method of claim 4 wherein the conveyance member is internally heated by a fluid.

6. The method of claim 1, wherein step (d) comprises heating the feedstock to between 170° C. and 220° C.

7. The method of claim 1, wherein the cellulosic feedstock is heated in the absence of the addition of moisture.

8. The method of claim 1, wherein step (a) comprises providing a cellulosic feedstock at a temperature between 5° C. and 100° C. and a moisture content between 30 and 60 wt %.

9. The method of claim 8, wherein the cellulosic feedstock has a temperature between 50° C. and 70° C. and a moisture content between 45 and 60 wt %.

10. The method of claim 1, wherein the treatment chamber is operated at a fill volume of the cellulosic feedstock of from 5% to 30%.

11. The method of claim 10, wherein the fill volume of the cellulosic feedstock in the chamber is from 5% to 20%.

12. The method of claim 1, further comprising operating the chamber at a pressure of between 75 and 500 pounds per square inch gauge (PSIG).

13. The method of claim 1, further comprising operating the chamber at a pressure of between 170 and 265 PSIG.

14. The method of claim 1, further comprising subjecting the cellulosic feedstock to a downstream hydrolysis process in the hydrolysis chamber.

15. The method of claim 1, wherein the hydrolysis chamber is contiguous with the treatment chamber.

16. The method of claim 1, wherein the treatment chamber is at the same pressure as the hydrolysis chamber.

17. The method of claim 1, wherein the treatment chamber has an outlet and the hydrolysis chamber has an inlet and the method further comprises conveying the cellulosic feedstock through a conduit connecting the treatment chamber and the hydrolysis chamber.

18. The method of claim 17 wherein the inlet is above the outlet and the method further comprises conveying the cellulosic feedstock downwardly from the treatment chamber to the hydrolysis chamber.

19. The method of claim 1, further comprising sweeping a lower surface to convey the cellulosic feedstock through the treatment chamber.

20. The method of claim 1, wherein the conveyance member comprises a rotary shaft extending longitudinally through the treatment chamber and a plurality of paddles extending radially outwardly from the shaft, and the conveyance member includes a fluid conduit extending longitudinally through at least one of the shaft and the plurality of paddle ducts, and wherein the step of heating the cellulosic feedstock comprises injecting a heated fluid through the fluid conduit.

21. The method of claim 1, further comprising rotating the conveyance member at a rate of between 25 and 150 RPM.

22. The method of claim 21, comprising rotating the conveyance member between 50 and 100 RPM.

23. The method of claim 1, further comprising maintaining the feedstock air born for at least 40% of its residence time in the treatment chamber.

24. An apparatus comprising:
a) a shell defining a pressurizable treatment chamber having a lower inner surface, the shell having an inlet and an outlet spaced longitudinally apart from the inlet to define an axial length, the outlet being at a pressure comparable to a hydrolysis chamber downstream from the treatment chamber;
b) a mixing and conveyance member housed within the shell; and,
c) a heating member configured to heat at least one of the shell and the mixing and conveyance member whereby the cellulosic feedstock is heat-treated prior to hydrolysis.

25. The apparatus of claim 24, wherein the pressurizable treatment chamber is contiguous with the hydrolysis chamber.

26. The apparatus of claim 24, wherein the pressurizable treatment chamber and the hydrolysis chamber are provided within the shell.

27. The apparatus of claim 24, wherein the treatment chamber and the hydrolysis chamber are provided in separate vessels and are connected by a conduit.

28. The apparatus of claim 27, wherein the outlet of the pressurizable treatment chamber is above an inlet of the hydrolysis chamber.

29. The apparatus of claim 24, wherein the conveyance member is configured to disperse the feedstock throughout the treatment chamber.

30. The apparatus of claim 24, wherein the heating member comprises at least one of a heating jacket and a fluid flow conduit internal to the mixing and conveyance member.

31. The apparatus of claim 24, wherein the fluid flow conduit is isolated from fluid flow communication with the treatment chamber.

32. The apparatus of claim 24, wherein the mixing and conveyance member comprises at least one portion configured to sweep the lower inner surface of the treatment chamber.

33. The apparatus of claim 24, wherein the hydrolysis chamber has a conveyance member and the mixing and conveyance member is operable at a higher RPM then the conveyance member.
